(19) United States
(12) Patent Application Publication
(10) Pub. No.: US 2010/0262403 A1
(43) Pub. Date: Oct. 14, 2010

(54) SYSTEMS AND METHODS FOR MONITORING WATER HEATERS OR BOILERS

(75) Inventors: Michael W. Gordon, East Grand Rapids, MI (US); Eric Truskoski, Grandville, MI (US)

Correspondence Address: RATNERPRESTIA, P.O. BOX 980, VALLEY FORGE, PA, 19482, US

(73) Assignee: Bradford White Corporation, Ambler, PA (US)

(21) Appl. No.: 12/422,086

(22) Filed: Apr. 10, 2009

(51) Int. Cl. G06F 15/00

(52) U.S. Cl. 702/183

(57) ABSTRACT

A system for monitoring water heaters. The system includes a central monitoring station and a plurality of water heater systems. The central monitoring station includes a computer, and each water heater system includes a water heater and one or more sensors for sensing one or more conditions of the water heater. The one or more conditions include one or more fault states, each indicating a reduced ability of the water heater to deliver hot water at a set temperature. The one or more sensors are in communication with the computer of the central monitoring station to provide data indicating the one or more conditions to the computer.

### FIELD OF INVENTION

The present invention relates to systems and methods for monitoring water heaters or boilers and, more specifically, to systems and methods for monitoring remote water heaters or boilers to track their performance from a central location to minimize their downtime.

### BACKGROUND OF THE INVENTION

Water heaters or boilers periodically suffer from abnormal operating states or conditions, e.g., fault conditions, failures, etc., that can result in, or coincide with, the water heaters' or boilers' performance degrading, possibly to the point of shutdown. Uninterrupted or predictable operation of water heating systems is desired in residential, commercial, and industrial environments. For example, in commercial facilities, such as in restaurants, medical facilities, etc., impaired water heaters or boilers may go unnoticed for a period of time. Problems may only be noticed when the water heaters or boilers fail to deliver hot water, thereby causing inconvenience or even necessitating the shutdown of the facility in which they are situated. Such inconvenience or shutdown is undesirable as it impedes customer service, tarnishes the reputation of the facility, and can lead to lost revenues.

### SUMMARY OF THE INVENTION

One aspect of the present invention is directed to a system for monitoring water heaters. The system includes a central monitoring station and a plurality of water heater systems. The central monitoring station includes a computer, and each water heater system includes a water heater and one or more sensors for sensing one or more conditions of the water heater. The one or more conditions include one or more fault states, each indicating a reduced ability of the water heater to deliver hot water at a set temperature. The one or more sensors are in communication with the computer of the central monitoring station to provide data indicating the one or more conditions from the one or more sensors to the computer.

Another aspect of the present invention is directed to a method of monitoring water heaters. The method includes a step of establishing communication with one or more water heater systems. Each water heater system includes a water heater and one or more sensors for sensing one or more conditions of the water heater. The one or more conditions include one or more fault states, each indicating a reduced ability of the water heater to deliver hot water at a set temperature. The one or more sensors are configured to output data representing the one or more conditions of the water heater. The method further includes a step of receiving the data outputted by the one or more sensors of each water heater system and a step of analyzing the received data to determine whether the water heater of each water heater system is operating within acceptable ranges of operation. Data regarding the one or more conditions of the water heater of each water heater system are stored in a storage device.

Yet another aspect of the present invention is directed to a method of monitoring water heater systems. The method includes a step of establishing a monitoring system for monitoring conditions of one or more water heater systems located in a location of an end user of the one or more water heater systems. The conditions include one or more faults states, each indicating a reduced ability of a respective water heater system to deliver hot water at a set temperature. Each of the one or more water heater systems includes a respective water heater and respective one or more sensors for sensing one or more conditions of the respective water heater. The respective one or more sensors are configured to output data indicating the one or more conditions. The method further includes a step of establishing a contractual relationship with the end user of the one or more water heater systems by which the end user pays to have the one or more water heater systems monitored by the monitoring system and a step of monitoring the one or more water heater systems using the monitoring system.

### BRIEF DESCRIPTION OF THE DRAWINGS

The invention may be understood from the following detailed description when read in connection with the drawings. Included in the drawings are the following figures:

FIG. 1 illustrates a system for monitoring a plurality of water heaters, each water heater connected to a gateway and a water heater control system, in accordance with an exemplary embodiment of the present invention;

FIG. 2 illustrates the gateways and the control systems of the water heaters of FIG. 1 in further detail, in accordance with an exemplary embodiment of the present invention;

FIG. 3 illustrates a method for monitoring water heaters, in accordance with an exemplary embodiment of the present invention;

FIG. 4 illustrates a database table of system-level information for a water heater system, in accordance with an exemplary embodiment of the present invention;

FIG. 5 illustrates a database table for sensor data received for a water heater system, in accordance with an exemplary embodiment of the present invention;

FIG. 6 illustrates a method by which an end user provides payments to a manufacturer of water heaters, in accordance with an exemplary embodiment of the present invention;

FIG. 7 illustrates a database table of enrollment information for end users enrolled in a system for monitoring a plurality of water heaters, in accordance with an exemplary embodiment of the present invention; and

FIG. 8 illustrates a functional block diagram of a system for monitoring a plurality of water heaters, in accordance with an exemplary embodiment of the present invention.

### DETAILED DESCRIPTION OF THE INVENTION

Exemplary features of selected embodiments of this invention will now be described with reference to the figures. It will be appreciated that the spirit and scope of the invention is not limited to the embodiments selected for illustration. Also, it should be noted that the drawings are not rendered to any particular scale or proportion. It is contemplated that any of the exemplary configurations and materials and sizes described hereafter can be modified within the scope of this invention.

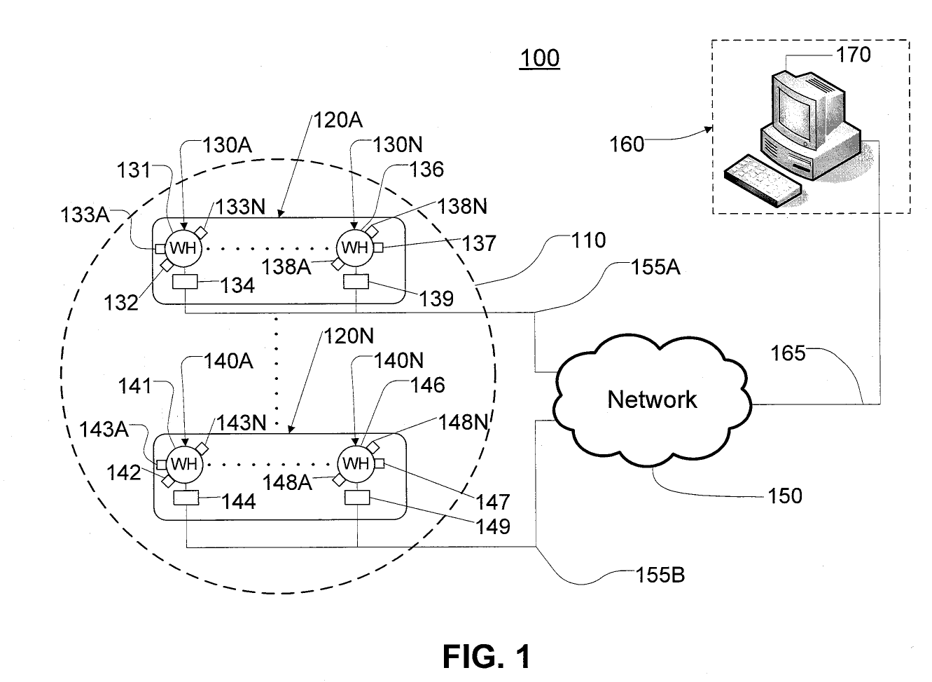

Referring now to FIG. 1, there is illustrated an exemplary embodiment of a system, generally designated as 100, for monitoring a plurality of water heaters located at a plurality of sites in a region 110, in accordance with an exemplary embodiment of the present invention. In the embodiment illustrated in FIG. 1, the region 110 includes a plurality of sites 120A through 120N (N sites). It is to be understood that the monitoring system 100 is not limited to monitoring N sites but may monitor a number of sites other than N, including a single site. Further, it is to be understood that, though the description below is made with reference to water heaters and water heater systems, such description is relevant to boilers and boiler systems, respectively, and to other appliances.

Each site includes one or more water heater systems. In the exemplary embodiment of the system 100 illustrated in FIG. 1, the site 120A includes a plurality (N) of water heater systems 130A through 130N, and the site 120N includes a plurality (N) of water heater systems 140A through 140N. It is to be understood that each site may include a respective number of water heater systems other than N, including one water heater system, and that each site may include a number of water heater systems different from other sites. Each site may be operated by a different end user, but it is to be understood that one end user may operate more than one site.

The sites 120 are located in residential, commercial, and industrial environments or a combination thereof. Examples of types of such sites include medical facilities, restaurants, offices, retail stores, single-unit and multiple-unit residences, commercial sites, industrial sites, etc. The site 120A is located remotely from the site 120N. In other words, the water heater systems 130 in the site 120A are installed in one building, and the water heater systems 140 in the site 120N are installed in another building.

As is explained below, the system 100 monitors the water heater systems in the sites 120. Such monitoring aids in observing, diagnosing, and/or repairing problems in water heater systems soon after or even before such problems result in water heater failure. Failed or failing water heater systems, ultimately exhibited through the reduced ability or inability to deliver hot water, cause inconvenience, impede customer service, tarnish the reputation of the facility in which the failed systems are located (i.e., the facility corresponding to the site), and can lead to lost revenues.

For example, where the site 120A is a restaurant, a failure of one or more of the water heater systems 130, to the point of insufficient production of hot water, could require the restaurant to close down as it would have inadequate hot water to clean dishes, glasses, etc. As described below, the system 100 facilitates continued operation of the sites 120A through 120N and, therefore, reduces the costs associated with failed water heater systems.

Each water heater system 130 includes a water heater, one or more sensors, a water heater control, and a gateway. Specifically, the water heater system 130A includes a water heater 131, a water heater control 132, a plurality of sensors 133A-133N, and a gateway 134; the water heater system 130N includes a water heater 136, a water heater control 137, a plurality of sensors 138A-138N, and a gateway 139; the water heater system 140A includes a water heater 141, a water heater control 142, a plurality of sensors 143A-143N, and a gateway 144; and the water heater system 140N includes a water heater 146, a water heater control 147, a plurality of sensors 148A-148N, and a gateway 149.

The sensors 133, 138, 143, and 148 are transducers that sense activities, operating conditions, and/or operating states of, respectively, the water heaters 131, 136, 141, and 146 and provide indications of the sensed activities, operating conditions, and operating states as data embodied in electrical signals. The activities, operating conditions, and operating states include any of fuel usage, fuel levels, running states, fault states (e.g., failure, shutdown, electrical cutout, etc.), presence of vapors, water temperature, etc. Fault states indicate an inability or a reduced ability of a water heater to deliver hot water at a set temperature. The sensors 133, 138, 143, and 148 provide the data indicating the sensed activities, operating conditions, and/or operating states of the water heaters to the respective water heater controls 132, 137, 142, and 147. In addition to receiving sensed data from the sensors, the water heater controls also control various aspects of the water heaters' operations via transducers (not illustrated in FIG. 1).

In an exemplary embodiment, the water heater controls 132, 137, 142, and 147 include microcontrollers or microprocessors programmed to execute software instructions stored in a tangible recording medium within the water heater controls. The software instructions are executed by the microcontrollers or the microprocessors to cause the water heater controls 132, 137, 142, and 147 to receive the data communicated by the respective sensors 133, 138, 143, and 148, communicate the data to the respective gateways 134, 139, 144, and 149, and control the various aspects of the respective water heaters' operations. Alternatively, the respective sensors 133, 138, 143, and 148 optionally communicate the data directly to the respective gateways 134, 139, 144, and 149.

The gateways 134, 139, 144, and 149 gather the data provided to the respective water heater controls 132, 137, 142, and 147 by the respective sensors and transmit the gathered data to a computer system 170 located at a centralized monitoring station 160. Communications take place over a network 150, which, in an exemplary embodiment, is a broadband network, such as the Internet, a satellite communications link, or another acceptable means for communicating data. Specifically, according to the illustrated embodiment the gateways 134 and 139 send the data received from the respective sensors 133 and 138 over the network 150 via a communications link 155A, and the gateways 144 and 149 send the data received from the respective sensors 143 and 148 over the network 150 via a communications link 155B. The computer system 170 located at the centralized monitoring station 160 communicates with the network 150 via a communications link 165 to receive the data from the gateways 134, 139, 144, and 149. In an exemplary embodiment, the communication links 155A, 155B, and 165 are Internet communication links.

In an exemplary embodiment, the gateways 134, 139, 144, and 149 include microcontrollers or microprocessors programmed to execute software instructions stored in a tangible recording medium within the gateways. The software instructions are executed by the microcontrollers or the microprocessors to cause the gateways to receive the data communicated by the respective water heater controls 132, 137, 142, and 147 and to communicate the data to the computer system 170.

The computer system 170 includes a mass storage device, such as one or more arrays of hard drives, tape drives, optical recorders, etc., for storing the data received from the gateways 134, 139, 144, and 149. It is to be understood that although the computer system 170 is illustrated in FIG. 1 as a single-unit personal computer, the computer system 170 may be embodied as a network of computers. Such network may include one or more mass storage devices accessible by the computers in the network. Accordingly, the discussion below pertaining to the computer system 170 applies to the computer system 170 being embodied either as a computer or as a network of computers.

The computer system 170 also includes one or more web servers (not illustrated) by which the gateways 134, 139, 144, and 149 send the data to the computer system 170. Specifically, the web servers in the computer system 170 host a website through which the gateways 134, 139, 144, and 149 connect to the computer system 170 to send such data. For certain received data, the computer system 170 stores the received data in the mass storage device within the computer system 170 without analyzing the data further. In an exemplary embodiment, the data is stored within a computer database tangibly embodied in the mass storage device.

Data may be displayed as it is received by the computer system 170, or historical data may be accessed from the mass storage device at any time and displayed. In an exemplary embodiment, display may be made in a webpage, hosted by the computer system 170, that illustrates the received data in textual and graphic form. The webpage is hosted on a website, which, in the case of the computer system 170 being embodied as a network of computers, may be accessed externally to the computer system 170 via remote computers (not illustrated) or internally by a computer within the computer system 170. Thus, the website is configured to allow computers (not illustrated) remote from the computer system 170 or other computers in the computer system 170 to access data stored within the computer system 170 to allow users of such computers to monitor the water heater systems of the system 100. In an exemplary embodiment, the website is a secure website.

An example of displayed historical data includes a textual or graphic representation of the temperature of one of the water heaters 131, 136, 141, and 146. Upon command of the computer (either internal to the computer system 170 or external to it) requesting historical temperature data be displayed for a particular water heater at a particular site (120A through 120N) via a webpage on the website hosted by the computer system 170, the computer system 170 accesses the mass storage device, retrieves the requested data (e.g., from the database where it is stored), and hosts it in the webpage to the requesting computer.

The computer system 170 is not limited to displaying and/or hosting historical data. Rather, the computer system 170 may host real-time data to the requesting computer as the data is received via the network 150 from the gateways 134, 139, 144, and 149. The real-time data is hosted by the computer system 170, which is programmed to execute software instructions stored in a tangible recording medium within the computer system 170 to perform such hosting. Thus, an end user (operator of one of the sites 120A through 120N) or a user in the computer system 170 may monitor a site (any of sites 120) remotely without being present at the site.

Periodically, data regarding one or more water heaters at one or more sites is accumulated and presented in a report to an end user. The report is generated by the computer system 170, which is programmed to execute software instructions stored in a tangible recording medium within the computer system 170 to generate such reports. Such reports may be provided in electronic form (via email, via posting on a secure website, etc.) or in paper form (via mail, via fax, etc.). Thus, in the case of the site 120A, the end user who operates the site 120A will receive a report on the water heaters 131 and 136 for a given period. Such reports can allow the end user to analyze the operations of the water heaters 131 and 136 and budget for future operation, request upgrades or maintenance, etc. For example, the report may include data on fuel usage of the water heaters 131 and 136, which data allows the end user to budget for future fuel costs.

For certain received data, e.g., data indicating sensed activities, operating conditions, and/or operating states received from the gateways 134, 139, 144, and 149, the computer system 170 performs analysis on the received data. The computer system 170 is programmed to execute software instructions stored in a tangible recording medium within the computer system 170 to perform such analysis. Such analysis includes comparing certain received data to ranges of acceptable values stored in the computer system 170, e.g., in the mass storage device (database). If a piece of received data is not within the expected range, i.e., does not satisfy a predetermined threshold (upper or lower), the computer system 170 issues an alarm and/or notifies the entity operating the centralized monitoring station 160 of a potential problem. Such entity may then schedule a visit to the site including the problematic water heater for further diagnosis and correction. In an exemplary embodiment, the computer system 170 is programmed to provide an indication of the alarm conditions on the website by which the water heaters are monitored.

It is to be understood that some or all of functionality of the computer system 170 described herein may be carried out with the assistance of software instructions stored in a tangible medium or media within the computer system 170. The software instructions are executed by one or more processors of the computer system 170 to perform the functionality of computer system 170 described herein, including but not limited to automated processes for the following: (1) receiving the data communicated by the gateways 134, 139, 144, and 149, (2) storing received data in the mass storage device, (3) hosting the website, (4) displaying received or historical data, (5) receiving requests for display of historical data, (6) analyzing the received data, (7) generating the reports, and (8) providing the reports to end users.

The water heaters 131, 136, 141, and 146 are manufactured by a water heater manufacturer. In an exemplary embodiment, the water heater manufacturer assembles the system 100 and operates the centralized monitoring station 160. In another exemplary embodiment, the water heater manufacturer assembles the system 100 and contracts with another party (a monitoring contractor) to operate the centralized monitoring station 160 to provide monitoring services. In yet another exemplary embodiment, the monitoring contractor assembles the system 100 and operates the centralized monitoring station 160. In such embodiments, when the entity (the manufacturer or the monitoring contractor) operating the centralized monitoring station 160 detects a problem in a water heater, it dispatches diagnostic and/or repair services, e.g., a water heater servicer, to the site of the water heater to diagnose and correct the problem. In an exemplary embodiment, either the manufacturer or the operator of the centralized monitoring station 160 (e.g., the manufacturer or the monitoring contractor) contracts with the water heater servicer to perform such service when needed. The water heater servicer may be a plumbing professional, e.g., a plumber. In another exemplary embodiment, the water heater servicer is the water heater manufacturer.

According to still another exemplary embodiment, the user of the water heater systems optionally operates the centralized monitoring station 160. In such an embodiment, the user can contract directly with a water heater servicer to service any water heater that indicates an actual or prospective failure.

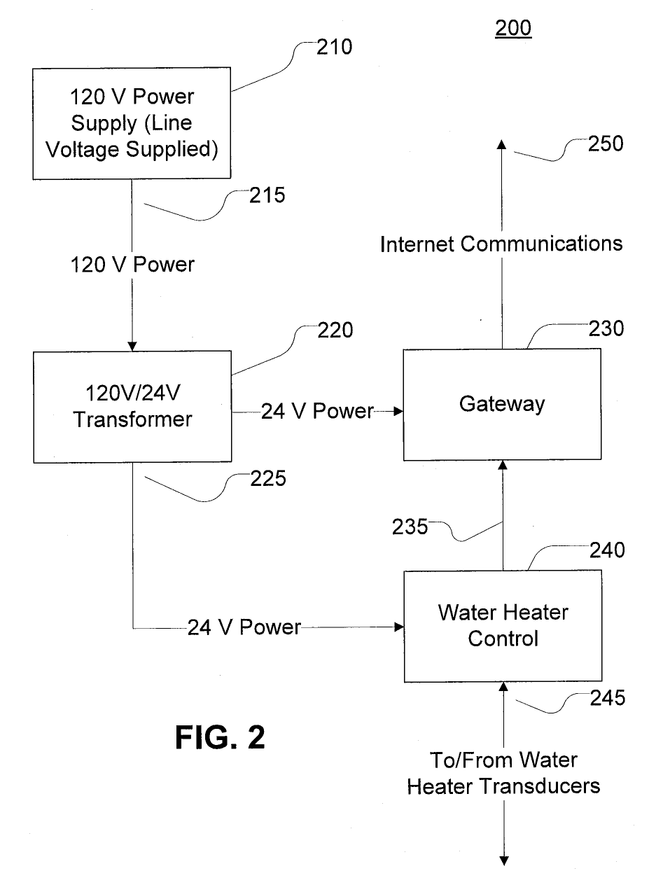

Referring now to FIG. 2, there is illustrated an electrical system 200 of an exemplary water heater system, in accordance with an exemplary embodiment of the present invention. The exemplary water heater system is any of water heater systems 130 or 140 illustrated in FIG. 1.

The electrical system 200 includes a 120V power supply 210. In an exemplary embodiment, the power supply 210 is line voltage obtained from an electrical outlet. The power supply 210 provides 120V power to a step-down transformer 220 via an electrical connection 215. The step-down transformer 220 converts the 120V line-supplied power to 24V and supplies 24V power to a water heater control 240 via an electrical connection 225. The water heater control 240 corresponds to any of the water heater controls 132, 137, 142, and 147 illustrated in FIG. 1.

The water heater control 240 communicates with the transducers of the water heater system via communication lines 245. The water heater control 240 receives electrical signals indicating activities, operating conditions, and operating states of the water heater system via the communication lines 245 and communicates the data to a gateway 230 via a communication line 235. The gateway 230 sends the data over a network (e.g., the Internet) to a central monitoring station (not illustrated in FIG. 2) via a communication line 250. The water heater control 240 also provides electrical signals to the transducers of the water heater systems to control aspects of operation of connected water heaters via the communication lines 245. The gateway 230 corresponds to any of the gateways 134, 139, 144, and 149 illustrated in FIG. 1.

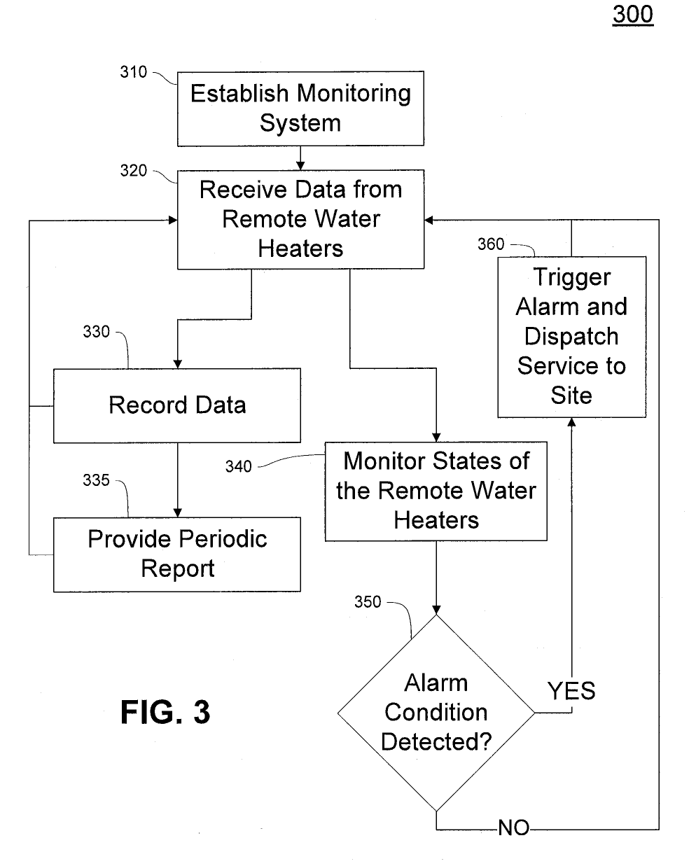

Referring now to FIG. 3, there is illustrated a method 300 for establishing and operating the system 100 to monitor water heaters, in accordance with an exemplary embodiment of the present invention. The method 300 begins with a step 310 of establishing the monitoring system 100.

In the step 310, the plurality of water heater systems 130 and 140 are installed at the respective sites 120A and 120N and wired for power and communications. Specifically, the water heaters 131 and 136 are coupled to the respective gateways 134 and 139 to communicate with the computer system 170 via the network 150, and the water heaters 141 and 146 are coupled to the respective gateways 144 and 149 to communicate with the computer system 170 via the network 150. The water heater systems 130 and 140 are installed at sites 120A through 120N within a geographical region 110 so that they are capable of being serviced and/or repaired by a water heater servicer. Thus, the size of the geographical region 110 is perhaps dependent upon various factors such as the size of the area the water heater servicer is able to visit within a predetermined period of time.

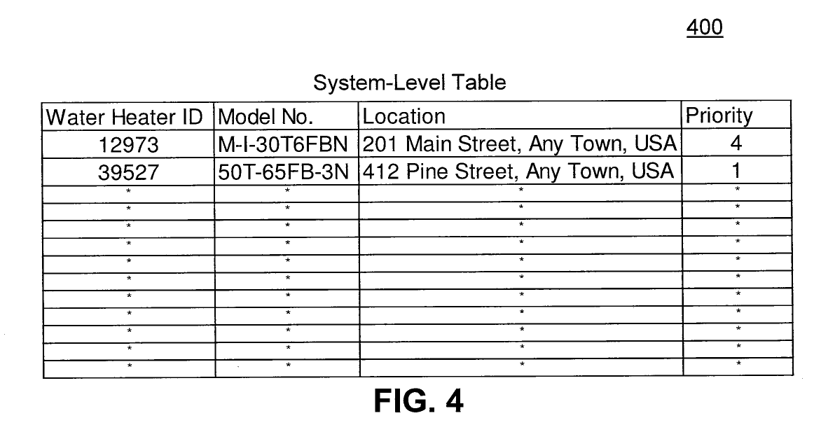

In the step 310, as the water heater systems 130 and 140 are installed, system-level information about the water heater systems 130 and 140 is stored in the mass storage device (database) of the computer system 170. Referring now to FIG. 4, there is illustrated a table 400 of system-level information stored in the computer database of the computer system 170, in accordance with an exemplary embodiment of the present invention. The table 400 stores a water heater serial number (“Water Heater ID”), model number (“Model No.”), location information (“Location”) concerning the location of each installed water heater system, and priority information (“Priority”) for each installed water heater system. Such information allows the computer system 170 to track installed water heater systems.

Specifically illustrated in FIG. 4 are examples of information on two exemplary water heaters in the system 100. The first has a serial number of 12973, a model number of M-I-30T6FBN, a location (address) of 201 Main Street, Any Town, USA, and a priority of 4. The second has a serial number of 39527, a model number of 50T-65FB-3N, a location (address) of 412 Pine Street, Any Town, USA, and a priority of 1.

Priority information indicates how critical hot water is to the site where the water heater is installed. An exemplary range of priority is 1 through 5, where 1 indicates the highest priority that hot water be consistently delivered and 5 indicates the lowest priority that hot water be consistently delivered. With regard to FIG. 4, a priority of 1 could indicate, for example, that the water heater having the serial number of 39527 is located at a hospital, and a priority of 4 could indicate, for example that the water heater having the serial number of 12973 is located at a residence. It is to be understood that the table 400 can include information on any number of water heaters located at a site, plurality of sites, in a region, or in a plurality of regions.

Continuing with FIG. 3, in a step 320, the gateways 134, 139, 144, and 149 gather data, e.g., information on sensed activities, operating conditions, and/or operating states, from the respective sensors 133, 138, 143, 148 and transmit the data over the network 150 to the computer system 170 with a date and time stamp indicating when each piece of data was collected. Data regarding each water heater is transmitted with identifying information, such as the serial number of the water heater and information indicating the type of sensor associated with the data, so that the system 170 can associate the data with the water heater and sensor to which it corresponds. As noted above, in an exemplary embodiment, the gateways 134, 139, 143, and 149 connect to a website in the computer system 170 to provide the data to the computer system 170. Thus, the computer system 170 receives the data from the water heater systems 130 and 140 via the website.

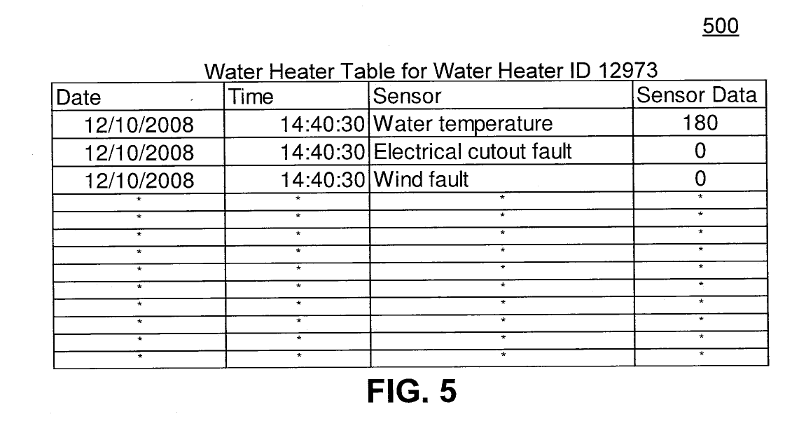

The computer system 170 processes the received data in steps 330 and 340. In the step 330, the computer system 170 stores part or all of the received data in the mass storage device, e.g., the computer database. In an exemplary embodiment, the computer system 170 stores data received for each water heater system in a table for each water heater system. An example of such a table for a particular water heater is illustrated in FIG. 5 and is designated as 500, in accordance with an exemplary embodiment of the present invention.

In the exemplary embodiment of the table 500 illustrated in FIG. 5, the table 500 stores data provided by sensors via a gateway for a water heater system having a water heater with a serial number of 12973. Specifically, the table 500 illustrates three data points for sensors of water heater serial no. 12973 reported at 14:40:30 on Dec. 10, 2008. These three data points relate to water temperature, wind fault, and electrical cutout (ECO) fault. The table 500 illustrates a reported water temperature of 180 F, a wind fault state of 0 (no wind fault), and an ECO state of 0 (no electrical cutout).

Continuing with FIG. 3, in the step 340, the computer system 170 monitors the activities, operating conditions, and operating states of the remote water heater systems 130 and 140 as indicated in the data received from the gateways. The monitoring includes presenting the data in a website hosted by the computer system 170 to the party monitoring the water heater systems.

In a step 350, the computer system 170 determines whether an alarm condition (or any condition requiring attention) exists in any of the water heaters 131, 136, 141, and 146 as indicated by sensor data. For a particular piece of data indicating a sensed activity, operating condition, and/or operating state received from a particular water heater, the computer system 170 accesses the mass storage device to determine a range of acceptable values (not illustrated) stored in the computer database. If the piece of data does not fall within the range of acceptable values stored in the computer database, i.e., if it is less that a predetermined minimum threshold, greater that a predetermined maximum threshold, or is a binary value indicating a fault state, for example, the computer system 170 determines that an alarm condition or a condition requiring attention is present, and in a step 360, an alarm or alert is triggered and the water heater servicer is dispatched to the site where the problematic water heater system is located to diagnose and repair the problem. The method 300 returns to the step 320. In the step 350, if the piece of data does fall within the range of acceptable values, it is determined that no alarm condition exists, and the method 300 returns to the step 320.

In an exemplary embodiment, the mass storage device includes tables (not illustrated) of acceptable ranges for sensor data for different water heater model numbers. Thus, the computer system 170 accesses such tables to determine the ranges of acceptable values for sensor data for a particular model number in the step 350.

In an exemplary embodiment, for example, in the step 350, the computer system 170 analyzes a data bit received from the water heater system 130A to determine whether the water heater 131 has a fault state indicating ECO. If the data bit equals 0, no fault exists. If the data bit equals 1, an ECO fault exists and the water heater servicer is dispatched to visit the site 120A to diagnose the problem with the water heater 131 in the step 360. The method returns to the step 320. If, in the step 350, the computer system 170 determines that no ECO fault condition exists in the water heater 131, the method returns to the step 320.

On a periodic basis, in a step 335, the computer system 170 generates a report on a monitored site, e.g., the site 130 or the site 140. The computer system 170 provides the report to the site operator in any of the forms discussed above. The method returns to the step 320. In an exemplary embodiment, the computer system 170 provides a report to the site operator on a monthly or quarterly basis.

As noted above, in an exemplary embodiment, the manufacturer of the water heaters in the water heater systems 130 and 140 assembles the system 100. In another embodiment, a water heater servicer does so. Thus, either the manufacturer or a party contracted by the manufacturer performs the step 310 of the method 300 in conjunction with the computer system 170 creating the tables 400 and 500 and/or records within the tables 400 and 500. The remaining steps of the method 300 illustrated in FIG. 3 are performed by the computer system 170 executing software instructions stored in a tangible medium and, by extension, the party operating the computer system 170. As also noted above, in an exemplary embodiment, the manufacturer contracts with a monitoring contractor to operate the centralized monitoring station 160 to monitor the water heater systems 130 and 140 at the N sites.

Two alternative embodiments are possible for the relationships among the end users, the manufacturer, and the water heater service provider established in the step 310. In a first embodiment, in the step 310, the end users contract with the manufacturer to participate in the monitoring system 100. In a second embodiment, the end users contract with the water heater servicer or the monitoring contractor to participate in the monitoring system 100. In either case, the end users enter into a service plan whereby they agree to pay for inclusion in the system 100 and for receiving the service of having their water heaters monitored and perhaps serviced on a continuous basis by the party operating the computer system 170.

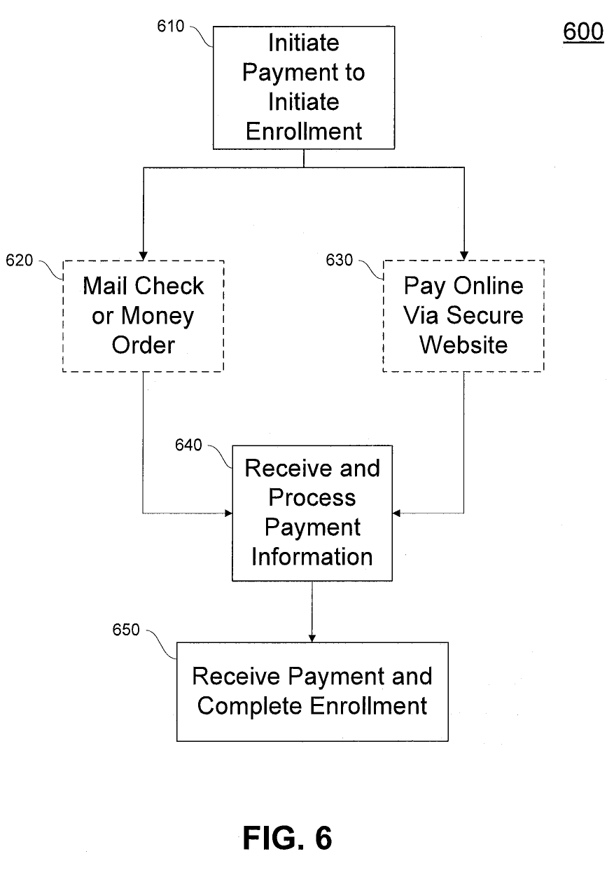

Referring now to FIG. 6, there is illustrated a method 600 by which an end user provides payments to a manufacturer to establish a contractual relationship with the manufacturer for enrollment in a system for monitoring a plurality of water heaters. An example of such a system is the system 100 described above.

The method 600 begins with a step 610 in which the end user initiates a payment to the manufacturer to enter into a contractual relationship with the manufacturer by which the manufacturer agrees to monitor the end user's water heaters, e.g., those at the site 120A, and enroll the user in the system 100. The end user has two options to pay for the monitoring: (1) by mailing a check or money order to the manufacturer or (2) by paying online. Other payment methods and structures are also contemplated.

In a step 620, the end user mails a check or money order and information identifying the end user to the manufacturer. Alternatively, in a step 630, the end user directs a web browser in a computer to a secure website configured to receive payment information and the end user's identification information. The end user enters payment information and identification information via the website. Such payment information may include either a credit card number or bank account information necessary to allow for automatic withdrawal from a bank account held by the end user. Such identification information may include the name of the end user, his or her billing address, etc.

In a step 640, the manufacturer (or a payment processor) processes the received payment information, and in a step 650 the manufacturer receives funds pursuant to the received payment information. In the step 640, the manufacturer also enrolls the end user in the system 100 for water heater monitoring. Specifically, the manufacturer stores the end user's identification information in a user enrollment table in the mass storage device (database) of the computer system 170 and creates an identification code for the end user and stores it in the user enrollment table. The manufacturer marks the user's enrollment status as active. Thus, the manufacturer performs the step 650. Water heaters of the end user are enrolled per the methods described above.

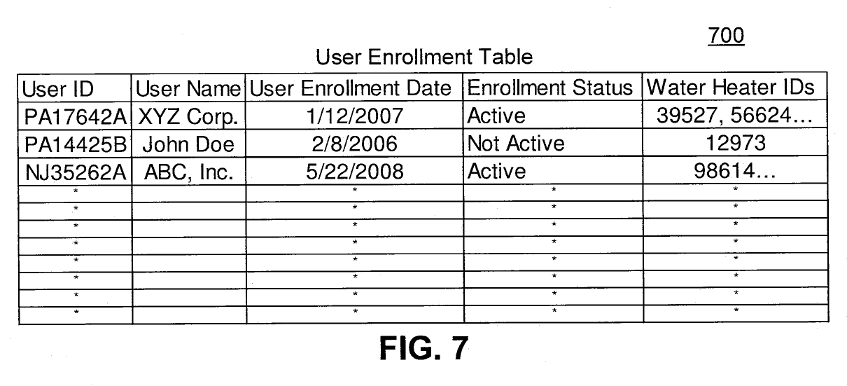

Referring now to FIG. 7, there is illustrated a table 700 of enrollment information stored in the database of the computer system 170, in accordance with an exemplary embodiment of the present invention. The table 700 stores an identification code for each enrolled user (“User ID”), the name of the enrolled user (either the user's personal name, in the case the user is a person, or the user's corporate name, in the case the user is a corporation) (“User Name”), the date the user was enrolled in the system 100 (“User Enrollment Date”), whether the end user is up-to-date in paying fees for participating in the system 100 (“Enrollment Status”), and identification numbers for each of the end user's water heaters included in the system 100 (“Water Heater IDs”).

Specifically illustrated in FIG. 7 are examples of information on three exemplary end users in the system 100. The first has an assigned identification code of PA17642A, a name of XYZ Corp., an enrollment date of Jan. 12, 2007, an enrollment status of “active,” and water heater identification codes 39527 and 56624. The second has an assigned identification code of PA14425B, a name of John Doe, an enrollment date of Feb. 8, 2006, an enrollment status of not active, and water heater identification code 12973. The third has an assigned identification code of NJ35262A, a name of ABC, Inc., an enrollment date of May 22, 2008, an enrollment status of “active,” and water heater identification code 98614.

The information in the table 700 allows the computer system 170 to track which water heaters in the system 100 belong to which end user. The table 700 also facilitates the computer system 170 in generating reports for the end users. Given a particular User Name, the table 700 allows the computer system 170 to identify the Water Heater IDs for the water heaters of that user. With knowledge of the Water Heater IDs, the computer system 170 can access the water heater table for each Water Heater ID, such as the table 500, to identify the collected data for each Water Heater ID. The computer system 170 is, thus, able to track collected water heater data to generate reports on the collected data.

It is to be understood that variations on the method 600 are contemplated in which the end user provides payments to a water heater servicer or a monitoring contractor to establish a contractual relationship with the water heater servicer or the monitoring contractor to have water heater systems of the end user monitored. Thus, either a water heater servicer or a monitoring contractor may perform the features of the step 650 of the method 600.

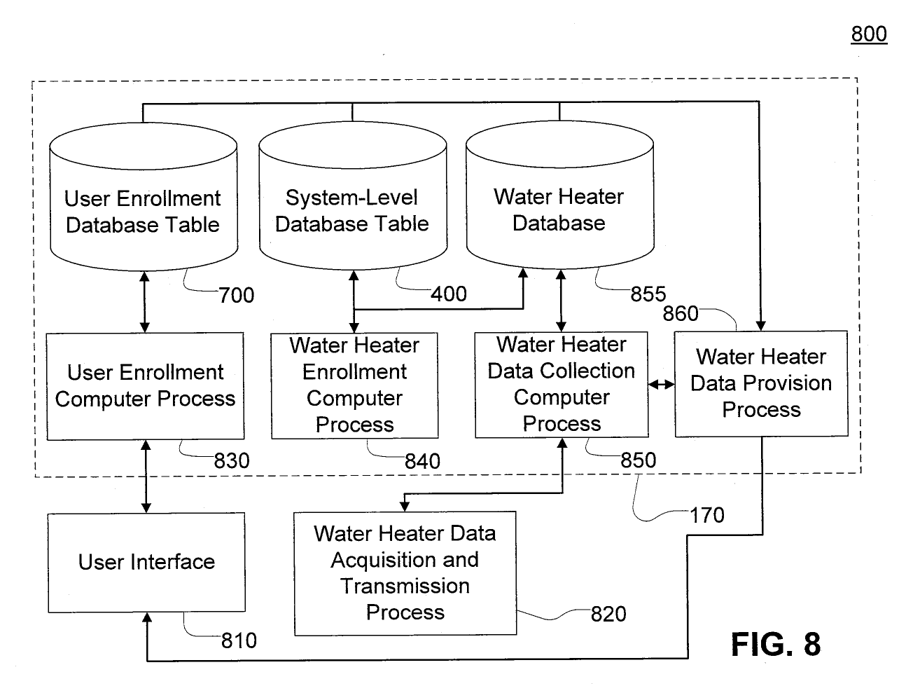

Referring now to FIG. 8, there is illustrated a functional block diagram 800 for the system 100, in accordance with an exemplary embodiment of the present invention. The functional block diagram 800 includes a user interface 810 which operates on a computer (not illustrated) of an end user in the system 100. It is through this user interface 810 that the user initiates payment in the step 610 and pays online in the step 630 in the method 600 described above. It is also through this user interface 810 that the end user may monitor one or more water heaters, e.g., their sensed activities, operating conditions, and operating states, and may receive the reports generated in the computer system 170.

The user interface 810 is coupled to a user enrollment computer process 830 performed in the computer system 170 and a water heater data provision process 860 also performed in the computer system 170. The end user inputs payment information and the end user's identification information into the user interface 810, which forwards the information to the user enrollment computer process 830. In an exemplary embodiment, the user interface 810 transmits the information to the user enrollment computer process 830 over the Internet.

The user enrollment computer process 830 receives the information and enrolls the end user in the user enrollment table 700. The process 830 also generates the user ID for the enrolled end user, stores the generated user ID in the table 700, and marks the enrollment status of the end user as “Active” when payment is received. An example of the features performed in the user enrollment computer process 830 is described above with respect to the step 650 of the method 600 described above.

The functional block diagram 800 also includes a water heater enrollment computer process 840 performed in the computer system 170. The process 840 is coupled to the system-level database table 400 and a water heater computer database 855. The water heater computer database 855 is tangibly embodied in the mass storage device in the computer system 170 and stores water heater tables for each of the installed water heaters in the system 100. For example, the database 855 includes the water heater table 500.

The water heater enrollment computer process 840 enrolls water heaters installed in the system 100. Specifically, the process 840 receives information identifying a newly installed water heater and stores such information in the table 400. The computer process 840 also creates a new table in the water heater computer database 855 for the newly installed water heater. Examples of the features performed by the water heater enrollment computer process 840 are described above with respect to the step 310 of the method 300 described above.

Also included in the functional block diagram 800 is a water heater data collection computer process 850 and a water heater data acquisition and transmission computer process 820. The water heater data acquisition and transmission computer process 820 is coupled to the water heater data collection computer process 850, which is coupled to the water heater computer database 855.

The water heater data acquisition and transmission computer process 820 is performed in the water heater control 240 and/or the gateway 230 of each water heater system in the system 100. The process 820 gathers information indicating activities, operating conditions, and operating states of its respective water heater system and transmits such information to the water heater data collection computer process 850. In an exemplary embodiment, the process 820 transmits the information to the process 850 over the Internet. The water heater data collection computer process 850 receives and stores such information in the water heater computer database 855. Examples of the features performed by the process 820 and the process 850 are described above with respect to the steps 320 and 330 of the method 300.

Finally, the functional block diagram 800 also includes a water heater data provision process 860 coupled to the water heater data collection computer process 850 and each of the user enrollment database table 700, the system-level database table 400, and the water heater database 855. The process 860 is coupled to the user interface 810. In an exemplary embodiment, the process 860 communicates with the user interface 810 over the Internet.

The process 860 is configured to provide real-time data on water heaters to the user interface 810. The process 860 receives real-time information on activities, operating conditions, and operating states of an end user's water heaters from the water heater database collection process 850 and hosts such information on a secure website to the end user. The end user may receive such information via the user interface 810 and thereby monitor his or her water heaters. An example of the features performed by the process 860 is described above with respect to the step 340 of the method 300. It is to be understood that the process 860 is also configured to perform the analysis on monitored water heaters described above with respect to the steps 340 and 350 of the method 300.

The process 860 is also configured to provide historical data on water heaters to the user interface 810. Such historical data may be provided in periodic reports. The process 860 retrieves information on end users from the user enrollment database table 700; identification information of water heaters for the end users from the system-level database table 400; and information regarding activities, operating conditions, and operation states of the water heaters from the water heater database 855. The process 860 generates reports based on the retrieved information. The reports may be provided to users via their respective user interfaces 810. An example of the features performed by the process 860 is described above with respect to the step 335 of the method 300.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A system for monitoring water heaters comprising:
a central monitoring station comprising a computer; and
a plurality of water heater systems, each water heater system including a water heater and one or more sensors for sensing one or more conditions of the water heater, the one or more conditions including one or more fault states, each indicating a reduced ability of the water heater to deliver hot water at a set temperature, the one or more sensors being in communication with the computer of the central monitoring station to provide data indicating the one or more conditions from the one or more sensors to the computer.

2. The system of claim 1, further including one or more gateways electrically coupled to the water heater systems, the one or more sensors of each water heater system being configured to communicate the data to the computer via the one or more gateways.

3. The system of claim 1, wherein each respective water heater system further includes a respective gateway electrically coupled to the one or more sensors of the respective water heater system, the one or more sensors of each respective water heater system communicating the data to the computer via the respective gateway.

4. The system of claim 1, wherein one or more of the water heater systems are located at a first site separated from other of the plurality of water heater systems.

5. The system of claim 1, wherein the water heaters are located within a geographic area serviceable by a water heater servicer.

6. The system of claim 1, wherein the central monitoring station further includes a storage device in which the computer stores the data indicating the one or more conditions of the water heater of each water heater system.

7. The system of claim 1, wherein the central monitoring station further includes a storage device in which the computer stores information regarding operating states of the water heater of each water heater system.

8. The system of claim 1, wherein the water heater of each water heater system is a boiler.

9. A method of monitoring water heaters comprising:
receiving data from one or more water heater systems, each water heater system including a water heater and one or more sensors for sensing one or more conditions of the water heater, the one or more conditions including one or more fault states, each indicating a reduced ability of the water heater to deliver hot water at a set temperature, the data representing the one or more conditions of the water heater of each water heater system;
analyzing the received data to determine whether the water heater of each water heater system is operating within acceptable ranges of operation; and
storing data regarding the one or more conditions of the water heater of each water heater system in a storage device.

10. The method of claim 9, wherein
the step of receiving comprises receiving the data representing the one or more conditions of the water heater of each water heater system via a respective water heater control of each water heater system.

11. The method of claim 9, wherein
the step of receiving comprises receiving the data representing the one or more conditions of the water heater of each water heater system via a respective gateway of each water heater system, wherein each respective gateway is coupled to a respective water heater control.

12. The method of claim 9, wherein the step of receiving comprises receiving the data from one or more water heater systems located within a geographic area serviceable by a water heater servicer.

13. The method of claim 9, further comprising:
dispatching a water heater servicer to a location of a water heater system not operating within an acceptable range of operation.

14. The method of claim 9, wherein
the steps of receiving, analyzing, and storing are performed in a computer system programmed with software instructions embodied in a tangible recording medium to perform such steps.

15. The method of claim 9, wherein
the steps of receiving and storing are performed in a water heater data collection computer process operating in a programmed computer, and
the step of analyzing is performed in a water heater data provision process operating in the programmed computer,
the water heater data provision process being coupled to the water heater data collection computer process to receive the data representing the one or more conditions of the water heater of each water heater system from the water heater data collection computer process.

16. A method of monitoring water heater systems comprising the steps of:
establishing a monitoring system for monitoring conditions of one or more water heater systems located in a location of an end user of the one or more water heater systems, the conditions including one or more fault states, each fault state indicating a reduced ability of a respective water heater system to deliver hot water at a set temperature, wherein each of the one or more water heater systems includes a respective water heater and respective one or more sensors for sensing one or more conditions of the respective water heater, the respective one or more sensors configured to output data indicating the one or more conditions;
establishing a contractual relationship with the end user of the one or more water heater systems by which the end user pays to have the one or more water heater systems monitored by the monitoring system; and
monitoring the one or more water heater systems using the monitoring system.

17. The method of claim 16, further comprising:
establishing a contractual relationship with a water heater servicer to service the one or more water heater systems on an as-needed basis.

18. The method of claim 16, wherein:
the step of monitoring comprises receiving data output by one or more sensors of each water heater system and determining whether the data indicate whether a water heater of each water heater system is operating within acceptable ranges of operation.

19. The method of claim 16, further comprising dispatching a water heater servicer to the location of the one or more water heaters when at least one of the one or more water heaters is not operating within an acceptable range of operation.

20. The method of claim 16, wherein the water heater systems are boiler systems.

21. The method of claim 16, wherein
the steps of establishing the contractual relationship and monitoring the one or more water heater systems are performed in a computer system programmed with software instructions embodied in a tangible recording medium to perform such steps.

22. The method of claim 16, wherein
the step of establishing the contractual relationship is performed in a user enrollment computer process operating in a programmed computer, and
the step of monitoring the one or more water heater systems is performed in a water heater data provision process operating in the programmed computer.
